(19) United States
(12) Patent Application Publication
(10) Pub. No.: US 2026/0268242 A1
(43) Pub. Date: Sep. 10, 2026

(54) PLANNING DEVICE, PLANNING METHOD, AND ENERGY SUPPLY METHOD

(71) Applicant: ENEOS Holdings, Inc., Tokyo (JP)

(72) Inventor: Ichiro OKUMO, Tokyo (JP)

(21) Appl. No.: 19/167,145

(22) PCT Filed: Mar. 19, 2024
(86) PCT No.: PCT/JP2024/010852

§ 371 Date: Sep. 19, 2025

(30) Foreign Application Priority Data
Mar. 29, 2023 (JP) 2023-053766

(51) Int. Cl. G06Q 10/0631; G06Q 50/06

(52) U.S. Cl. CPC G06Q 10/0631; G06Q 50/06

(57) ABSTRACT

A planning device includes: an information acquisition unit configured to acquire information related to hydrogen production and information related to hydrogen demand with respect to each of a plurality of regions, a storage facility of hydrogen or a hydrogen carrier being installed in each of the plurality of regions; and a delivery planning unit configured to create a delivery plan for delivering, to the storage facility, hydrogen or a hydrogen carrier produced at a production site different from the plurality of regions based on the information related to hydrogen production and information related to hydrogen demand.

### TECHNICAL FIELD

The present invention relates to a planning device, a planning method, and an energy supply method.

### BACKGROUND

In recent years, hydrogen has attracted attention as a new energy for promoting decarbonization. Various technologies have been proposed to efficiently store and transport hydrogen.

For example, Patent Document 1 discloses an operation management system for delivering hydride from a hydride production base to a plurality of dehydrogenation bases. The operation management system disclosed in Patent Document 1 acquires information related to the status of dehydrogenation from the plurality of dehydrogenation bases, comprehensively judges the status of dehydrogenation at each of the plurality of dehydrogenation bases, and then creates a delivery plan for delivering hydride to the plurality of dehydrogenation bases.

### RELATED ART DOCUMENT

### Patent Document

[Patent Document 1] Japanese Laid-open Patent Application Publication No. 2021-157750

### SUMMARY OF THE INVENTION

### Problem to Be Solved by the Invention

As hydrogen energy becomes more widespread, the range of delivery destinations of a hydrogen carrier are expected to diversify.

In view of the above technical problem, an aspect of the present invention aims to appropriately deliver a hydrogen carrier to a region where hydrogen or a hydrogen carrier is consumed.

### Means for Solving the Problem

A planning device according to an aspect of the present invention includes: an information acquisition unit configured to acquire information related to hydrogen production and information related to hydrogen demand for each of a plurality of regions, a storage facility for hydrogen or a hydrogen carrier being installed in each of the plurality of regions; and a plan creation unit configured to create a delivery plan for delivering, to the storage facility, hydrogen or a hydrogen carrier produced at a production site different from the plurality of regions based on the information related to the hydrogen production and the information related to the hydrogen demand.

### BRIEF DESCRIPTION OF THE DRAWINGS

FIG. 1 is a diagram illustrating an example of a delivery plan for a hydrogen carrier.

FIG. 2 is a block diagram illustrating an example of an overall configuration of a production site.

FIG. 3 is a block diagram illustrating an example of an overall configuration of a consumption region.

FIG. 4 is a block diagram illustrating an example of the overall configuration of the consumption region.

FIG. 5 is a block diagram illustrating an example of a hardware configuration of a computer.

FIG. 6 is a block diagram illustrating an example of a functional configuration of a planning device according to a first embodiment.

FIG. 7 is a flowchart illustrating an example of an energy supply method according to the first embodiment.

FIG. 8 is a block diagram illustrating an example of a functional configuration of a planning device according to a second embodiment.

FIG. 9 is a flowchart illustrating an example of an energy supply method according to the second embodiment.

### DESCRIPTION OF THE EMBODIMENTS

Embodiments of the present invention will be described below with reference to the attached drawings. Here, in the present specification and the drawings, components having substantially the same functions will be denoted by the same reference numerals and thus duplicate descriptions will be omitted.

### Embodiments

One embodiment of the present invention is an energy supply system for supplying energy from a production site for producing energy to a region (hereinafter referred to as a “consumption region”) where a storage facility for storing the energy and a consumer who consumes the energy stored in the storage facility are present. The energy in the present embodiment is hydrogen energy. Hydrogen energy is delivered from the production site to the consumption region by converting gaseous hydrogen (hydrogen gas) into a hydrogen carrier and supplied to the consumer present in the consumption region. Hydrogen energy may be delivered from the production site to the consumption region in the state of gaseous hydrogen and supplied to the consumer present in the consumption region. The hydrogen carrier is a substance in which hydrogen gas is changed into a state such as liquid that can be efficiently stored and transported. Hereinafter, the term “hydrogen” by itself refers to gaseous hydrogen (hydrogen gas).

In recent years, environmental problems such as global warming have become a global issue, and hydrogen, which does not generate carbon dioxide when used, has attracted attention as a new energy to promote decarbonization. In particular, hydrogen production using renewable energy, such as solar or wind power, can be expected to reduce carbon dioxide emissions further.

The supply capacity of electric power from renewable energy varies depending on a region. For example, a country that does not have sufficient power generation capacity from renewable energy can promote decarbonization by importing a hydrogen carrier from a country that has abundant power generation capacity from renewable energy.

Today, even a country that does not have sufficient power generation capacity may have sufficient power generation capacity in the future due to the spread of power generation facilities. However, the power generation amount of electric power from renewable energy fluctuates depending on the season and weather. It is desirable to produce hydrogen with surplus power, and thus the production capacity of hydrogen may become unstable according to the fluctuation of the power generation amount. With respect to the above, the demand for hydrogen does not depend on the season and weather, and thus it is desirable that the supply of hydrogen becomes stable.

When the power generation amount of electric power from renewable energy decreases, the hydrogen supply can be stabilized by reconverting a hydrogen carrier into hydrogen. For this purpose, it is necessary to store the hydrogen carrier in each consumption region in advance. Additionally, the appropriate storage amount of the hydrogen carrier in each consumption region varies depending on the power generation capacity and hydrogen production capacity of the consumption region. Therefore, it is preferable to predict the storage amount of the hydrogen carrier required in each consumption region and deliver the hydrogen carrier from the production site to the storage facility installed in each consumption region in advance. At this time, it is preferable to preferentially allocate the delivery amount to a consumption region where the hydrogen supply is insufficient.

The energy supply system in the present embodiment produces hydrogen at the production site and delivers the hydrogen or a hydrogen carrier converted from the hydrogen from the production site to the consumption region. Additionally, the energy supply system in the present embodiment includes a form of supplying, to the consumer, hydrogen obtained by reconverting the hydrogen carrier in the consumption region, and a form of supplying the hydrogen carrier itself to the consumer. The energy supply system in the present embodiment creates a delivery plan for delivering, to the storage facility for hydrogen or the hydrogen carrier installed in each consumption region, hydrogen or a hydrogen carrier shipped from the production site.

### Hydrogen Carrier

Materials that can be used as a hydrogen carrier include, for example, methylcyclohexane (MCH), ammonia (NH3), or liquid hydrogen (LH2: liquid H2). Methylcyclohexane can be obtained by reacting hydrogen with toluene. Ammonia can be obtained by reacting hydrogen with nitrogen. Liquid hydrogen is hydrogen that has been liquefied by cooling hydrogen to the boiling point (−253° C.) or below.

The hydrogen carrier may be reconverted to hydrogen by a chemical reaction, such as dehydrogenation, or it may be used as it is (in the state of the hydrogen carrier). Toluene obtained by dehydrogenating methylcyclohexane can be transported to the production site of the hydrogen carrier and reused for the production of new methylcyclohexane. Ammonia can be used as a raw material for fertilizer, chemical products, and the like, for example. Additionally, ammonia itself can also be used as a fuel. Liquid hydrogen can be used, for example, as a fuel for rockets and the like.

In the production site, hydrogen may be produced using electric power derived from renewable energy and converted into the hydrogen carrier. Additionally, in the consumption region, the hydrogen carrier may be reconverted into hydrogen using electric power derived from renewable energy. With this configuration, hydrogen or the hydrogen carrier can be used as clean energy with reduced carbon dioxide emissions in the cycle from production to use.

### Delivery Plan for Hydrogen Carrier

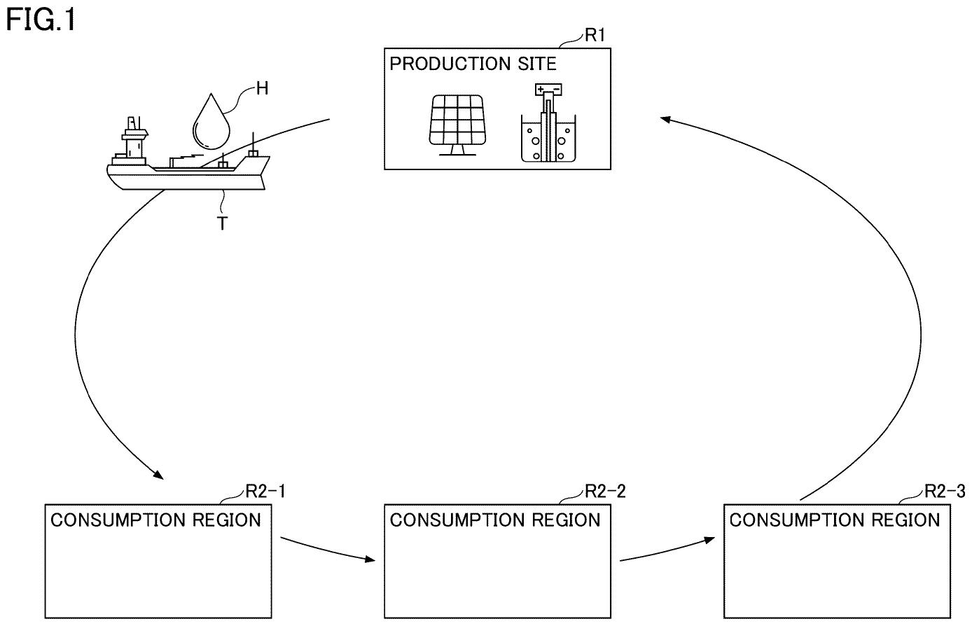

A delivery plan for the hydrogen carrier in the present embodiment will be described with reference to FIG. 1. FIG. 1 illustrates an example of the delivery plan for the hydrogen carrier in the present embodiment.

The delivery plan for the hydrogen carrier is a plan for delivering a hydrogen carrier produced at a production site to a plurality of consumption regions. As illustrated in FIG. 1, in the delivery plan of the present embodiment, a hydrogen carrier H is delivered from one or more production sites R1 to a plurality of consumption regions R2 (R2-1 to R2-3). The hydrogen carrier H is loaded into one or more tankers T and delivered to respective consumption regions R2-1 to R2-3. In each of the consumption regions R2-1 to R2-3, the hydrogen carrier loaded from the tanker T is stored in a hydrogen carrier tank.

The production site R1 and the consumption regions R2 may be different regions. The production site R1 and the consumption region R2 may be different countries or different regions in the same country. There may be a plurality of production sites R1. The number of the plurality of consumptions regions R2 is not limited, as long as there are the plurality of consumption regions R2. A transport route of the hydrogen carrier connecting the production site R1 and the consumption region R2 may consist solely of a sea route, or may include a land route or an air route.

For example, the tanker T in which the hydrogen carrier H is loaded at the production site R1 moves to the consumption region R2-1 and unloads the hydrogen carrier H in a delivery amount indicated in the delivery plan. Next, the tanker T moves to the consumption region R2-2 and unloads the hydrogen carrier H in a delivery amount indicated in the delivery plan. Subsequently, the tanker T moves to the consumption region R2-3 and unloads the hydrogen carrier H in a delivery amount indicated in the delivery plan. FIG. 1 illustrates an example in which one tanker T sequentially delivers the hydrogen carrier to each of the consumption regions R2-1 to R2-3, but a plurality of tankers T may individually deliver the hydrogen carrier from the production site R1 to the consumption regions R2-1 to R2-3.

### Overall Configuration of the Production Site

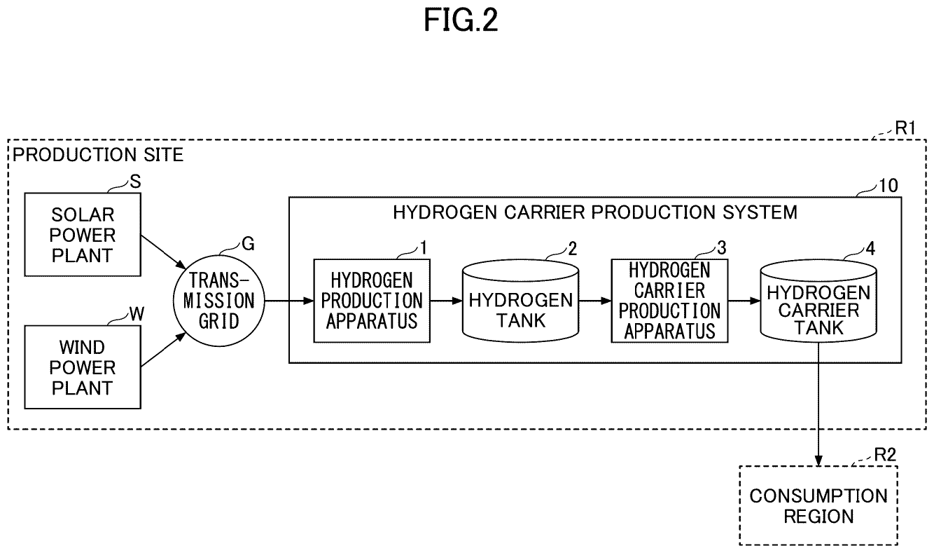

An overall configuration of the energy supply system at the production site will be described with reference to FIG. 2. FIG. 2 illustrates an example of an overall configuration of the production site in the present embodiment.

As illustrated in FIG. 2, a hydrogen carrier production system 10 is installed at the production site R1 in the present embodiment. The hydrogen carrier production system 10 includes a hydrogen production apparatus 1, a hydrogen tank 2, a hydrogen carrier production apparatus 3, and a hydrogen carrier tank 4.

The hydrogen carrier production system 10 is connected to a transmission grid G. The transmission grid G is connected to a solar power plant S and a wind power plant W that supply electric power derived from renewable energy. A thermal power plant, a nuclear power plant, and the like that supply electric power derived from energy other than renewable energy may be connected to the transmission grid G. The hydrogen carrier production system 10 receives the supply of electric power derived from renewable energy from the solar power plant S or the wind power plant W via the transmission grid G.

The hydrogen production apparatus 1 produces hydrogen by using the electric power supplied from the transmission grid G. For example, the hydrogen production apparatus 1 produces hydrogen by electrolyzing water stored in a water electrolyzer. The hydrogen produced by the hydrogen production apparatus 1 is stored in the hydrogen tank 2.

The hydrogen carrier production apparatus 3 converts the hydrogen supplied from the hydrogen tank 2 into the hydrogen carrier using the electric power supplied from the transmission grid G. An example of the hydrogen carrier is methylcyclohexane, ammonia or liquid hydrogen. The hydrogen carrier production apparatus 3 produces the hydrogen carrier by performing treatment corresponding to the type of hydrogen carrier. The hydrogen carrier produced by the hydrogen carrier production apparatus 3 is stored in the hydrogen carrier tank 4.

When the hydrogen carrier is methylcyclohexane, the hydrogen carrier production apparatus 3 produces methylcyclohexane by reacting the hydrogen supplied from the hydrogen tank 2 with toluene supplied from a toluene tank. The hydrogen carrier production apparatus 3 may incorporate an electrolyzer and directly produce methylcyclohexane bypassing the hydrogen production apparatus 1 and the hydrogen tank 2.

When the hydrogen carrier is ammonia, the hydrogen carrier production apparatus 3 produces ammonia by reacting the hydrogen supplied from the hydrogen tank 2 with nitrogen in the atmosphere. The nitrogen can be obtained by an air separator device or the like. When the hydrogen carrier is liquid hydrogen, the hydrogen carrier production apparatus 3 produces liquid hydrogen by cooling the hydrogen supplied from the hydrogen tank 2.

The hydrogen carrier stored in the hydrogen carrier tank 4 is transported from the production site R1 to the consumption region R2 by a transport means corresponding to the transport route between the production site R1 and the consumption region R2. For the transportation of the hydrogen carrier, for example, a tanker or the like is used by the sea route and a tank lorry or the like is used by the land route. However, the transport means is not limited to these, and any means may be used as long as the hydrogen carrier can be safely transported.

The hydrogen stored in the hydrogen tank 2 may be transported from the production site R1 to the consumption region R2 by a transport means corresponding to the transport route between the production site R1 and the consumption region R2.

### Overall Configuration of Consumption Region

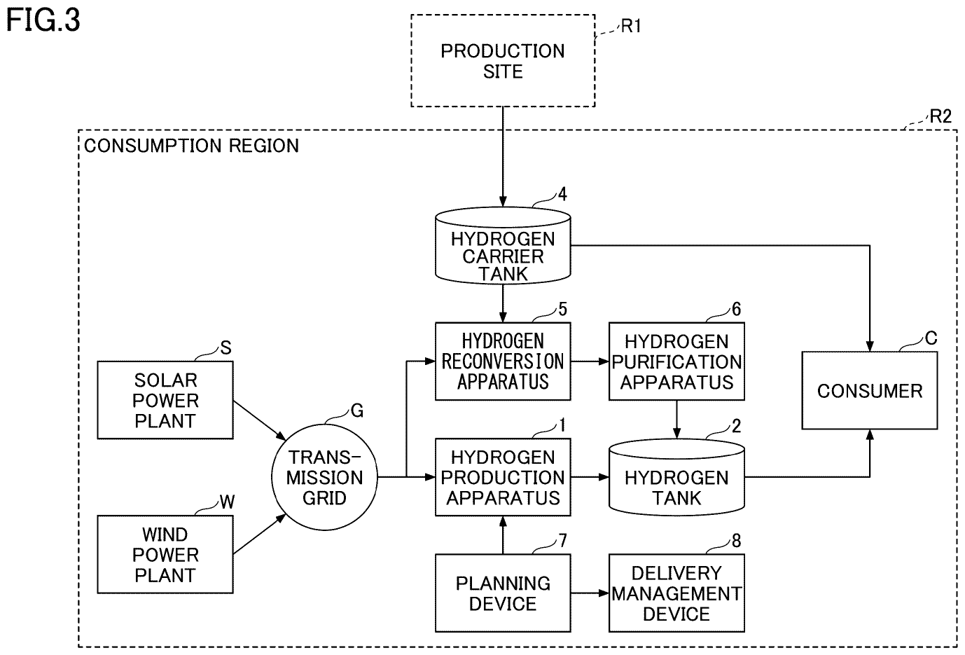

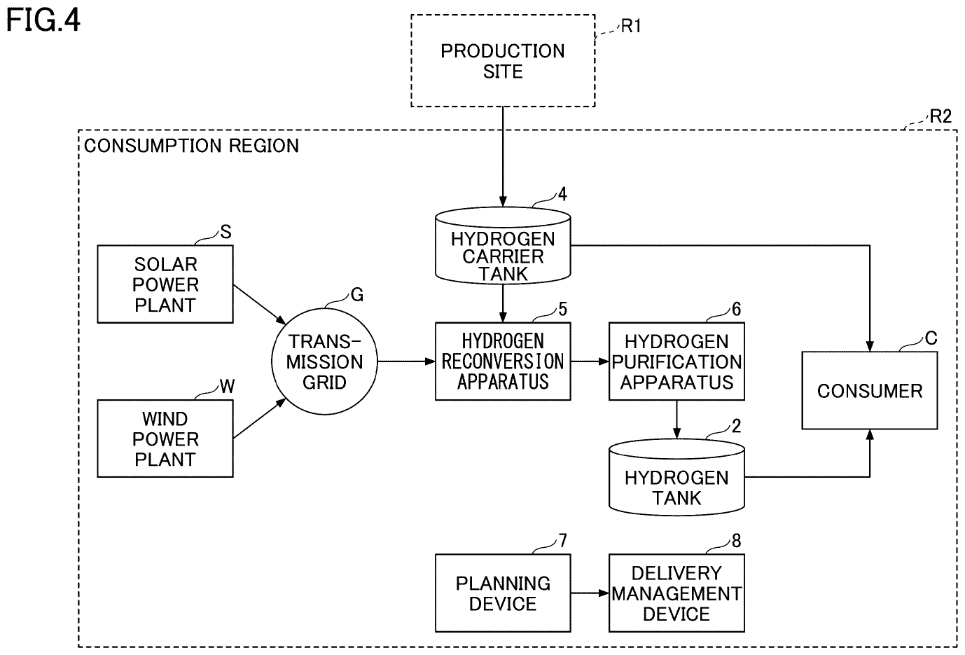

An overall configuration of the energy supply system in the consumption region will be described with reference to FIGS. 3 and 4. FIG. 3 is a diagram illustrating an example of the overall configuration of the consumption region in the present embodiment.

As illustrated in FIG. 3, in the consumption region R2 in the present embodiment, the hydrogen production apparatus 1 (an example of a production facility), the hydrogen tank 2, the hydrogen carrier tank 4 (an example of the storage facility), a hydrogen reconversion apparatus 5, a hydrogen purification apparatus 6, a planning device 7, and a delivery management device 8 are installed. As long as the hydrogen production apparatus 1, the hydrogen tank 2, the hydrogen carrier tank 4, the hydrogen reconversion apparatus 5, the hydrogen purification apparatus 6, the planning device 7, and the delivery management device 8 are installed in the consumption region R2, their geographical locations are not limited, and they may be installed in one facility or distributed in a plurality of facilities. Here, the planning device 7 and the delivery management device 8 are only required to be installed in any one of the consumption regions R2.

The hydrogen carrier tank 4 stores the hydrogen carrier delivered from the production site R1. The hydrogen reconversion apparatus 5 reconverts the hydrogen carrier supplied from the hydrogen carrier tank 4 into hydrogen. The hydrogen reconversion apparatus 5 reconverts the hydrogen carrier into hydrogen by performing treatment corresponding to the type of hydrogen carrier. The hydrogen produced by the hydrogen reconversion apparatus 5 is supplied to the hydrogen purification apparatus 6.

When the hydrogen carrier is methylcyclohexane, the hydrogen reconversion apparatus 5 separates the methylcyclohexane supplied from the hydrogen carrier tank 4 into hydrogen and toluene by a chemical reaction such as dehydrogenation. When the hydrogen carrier is ammonia, the hydrogen reconversion apparatus 5 reacts the ammonia supplied from the hydrogen carrier tank 4 with a catalyst to separate the ammonia into hydrogen and nitrogen. When the hydrogen carrier is liquid hydrogen, the liquid hydrogen supplied from the hydrogen carrier tank 4 is vaporized and reconverted into hydrogen.

The hydrogen purification apparatus 6 purifies the hydrogen obtained by the hydrogen reconversion apparatus 5 into hydrogen with high purity. The hydrogen purified by the hydrogen purification apparatus 6 is stored in the hydrogen tank 2. The hydrogen purified by the hydrogen purification apparatus 6 may be stored in a hydrogen tank different from the hydrogen tank 2.

The hydrogen delivered from the production site R1 may be stored in the hydrogen tank 2. The hydrogen delivered from the production site R1 may be stored in a hydrogen tank different from the hydrogen tank 2.

The hydrogen stored in the hydrogen tank 2 is supplied to a consumer C and consumed. The consumer C is, for example, a facility such as a steel plant, a power plant, a chemical plant, a hydrogen station, or a house. The supply of hydrogen to the consumer C may be carried by filling a container such as a hydrogen cylinder, or it may be transported via a pipeline installed in advance.

The hydrogen carrier stored in the hydrogen carrier tank 4 may be supplied to the consumer C as a hydrogen carrier and consumed. In this case, at the consumer C, a power generation facility that generates electric energy using the hydrogen carrier is installed. The power generation facility is, for example, a fuel cell or the like that generates electric power using the hydrogen obtained by dehydrogenating methylcyclohexane. Additionally, the power generation facility may be, for example, a power generator or the like that generates electric power by burning ammonia gas obtained by vaporizing ammonia.

The consumer C may be a facility where any of the hydrogen production apparatus 1, the hydrogen tank 2, the hydrogen carrier tank 4, the hydrogen reconversion apparatus 5, the hydrogen purification apparatus 6, the planning device 7, or the delivery management device 8 is installed. For example, the facility where any of the hydrogen production apparatus 1, the hydrogen tank 2, the hydrogen carrier tank 4, the hydrogen reconversion apparatus 5, the hydrogen purification apparatus 6, the planning device 7, or the delivery management device 8 is installed may include a power generation facility such as a fuel cell or the like, and may be operated by the electric power generated using the hydrogen stored in the hydrogen tank 2 or the hydrogen carrier stored in the hydrogen carrier tank 4.

The planning device 7 is an information processing device, such as a personal computer, a workstation, or a server that creates a delivery plan for the hydrogen carrier. The planning device 7 acquires information related to hydrogen production and information related to hydrogen demand in each of the consumption regions, and creates a delivery plan for delivering, to each of the consumption regions R2, the hydrogen carrier shipped from the production site R1 based on these information.

The delivery management device 8 is an information processing device, such as a personal computer, a workstation, or a server that manages the delivery of the hydrogen carrier. In accordance with the delivery plan created by the planning device 7, the delivery management device 8 transmits, to a delivery subject who delivers the hydrogen carrier, a delivery instruction for delivering the hydrogen carrier to the consumption region R2.

The delivery instruction for the hydrogen carrier includes the time (or deadline), the delivery quantity, and the like for each of the consumption regions R2 to which the hydrogen carrier is delivered. The delivery subject for the hydrogen carrier includes, for example, a tanker (specifically, a crew of the tanker, a shipping company that manages the operation of the tanker, or the like) that transports the hydrogen carrier on a sea route or a tank lorry (specifically, an operator of the tank lorry or a land transport company that manages the operation of the tank lorry) that transports the hydrogen carrier on a land route.

In accordance with the delivery plan created by the planning device 7, the delivery management device 8 may transmit, to a delivery subject of hydrogen energy, a delivery instruction for distributing hydrogen energy to the consumer C in the consumption region R2. In this case, the delivery instruction of the hydrogen energy includes the type of energy to be delivered (hydrogen or hydrogen carrier), the time (or deadline), the delivery quantity, and the like for each of the consumers C. The delivery subject of hydrogen energy includes a truck (specifically, a truck driver, a land transportation company that manage truck operations, or the like) that transports hydrogen or a container filled with the hydrogen carrier to the consumer C.

In the consumption region R2, a production facility is not required to be installed. FIG. 4 is a diagram illustrating another example of the overall configuration of the consumption region in the present embodiment. As illustrated in FIG. 4, the hydrogen tank 2, the hydrogen carrier tank 4 (an example of the storage facility), the hydrogen reconversion apparatus 5, the hydrogen purification apparatus 6, the planning device 7, and the delivery management device 8 are installed in the consumption region R2 in another example.

FIGS. 2 to 4 illustrate an example of the configuration in which the planning device 7 and the delivery management device 8 are installed in one consumption region R2 among the plurality of consumption regions R2, but the locations of the planning device 7 and the delivery management device 8 are not limited thereto. For example, the planning device 7 and the delivery management device 8 may be installed in the production site R1. Additionally, for example, the planning device 7 and the delivery management device 8 may be installed in a region different from either the production site R1 or the consumption region R2.

Furthermore, the planning device 7 and the delivery management device 8 are not required to be installed in the same region. For example, the planning device 7 may be installed in the production site R1 and the delivery management device 8 may be installed in the consumption region R2, or vice versa. Additionally, for example, the planning device 7 may be installed in the production site R1 or the consumption region R2, and the delivery management device 8 may be installed in a region different from either the production site R1 or the consumption region R2, or vice versa.

Here, the overall configuration of the energy supply system illustrated in FIGS. 2 to 4 is an example, and various system configuration examples can be used depending on the application and purpose. For example, the energy supply system may include a plurality of instances of one or more of the hydrogen production apparatus 1, the hydrogen carrier production apparatus 3, the hydrogen reconversion apparatus 5, the hydrogen purification apparatus 6, the planning device 7, or the delivery management device 8. For example, the planning device 7 or the delivery management device 8 may be implemented by a plurality of computers or may be implemented as a cloud computing service. The classification of the devices, such as the hydrogen production apparatus 1, the hydrogen carrier production apparatus 3, the hydrogen reconversion apparatus 5, the hydrogen purification apparatus 6, the planning device 7, and the delivery management device 8 illustrated in FIGS. 2 to 4 is an example.

### Hardware Configuration of Energy Supply System

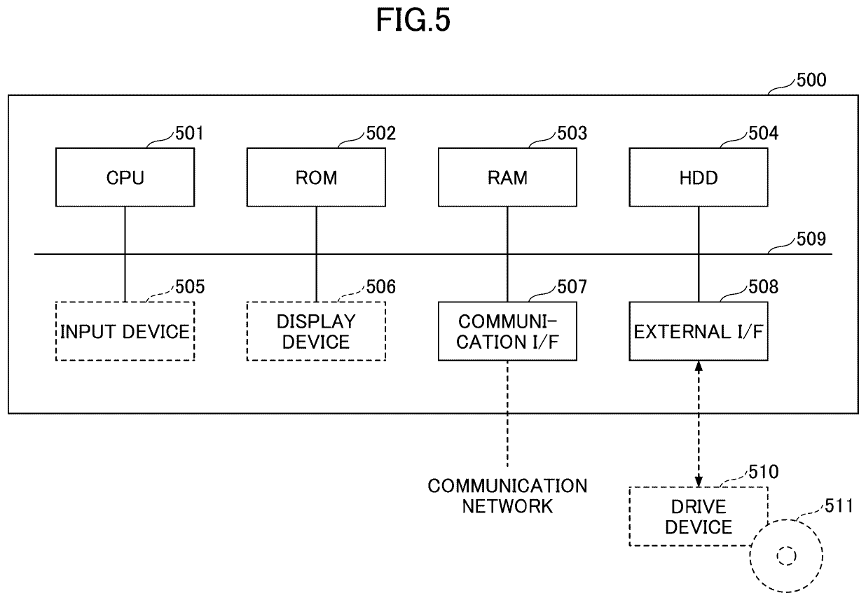

A hardware configuration of each of the devices included in the energy supply system of the present embodiment will be described with reference to FIG. 5.

### Hardware Configuration of Computer

The planning device 7 and the delivery management device 8 in the present embodiment are implemented by, for example, a computer. FIG. 5 is a block diagram illustrating an example of the hardware configuration of the computer in the present embodiment.

As illustrated in FIG. 5, a computer 500 in the present embodiment includes a central processing unit (CPU) 501, a read only memory (ROM) 502, a random access memory (RAM) 503, a hard disk drive (HDD) 504, an input device 505, a display device 506, a communication interface (I/F) 507, and an external I/F 508. The CPU 501, the ROM 502, and the RAM 503 form what is called a computer. The hardware components of the computer 500 are connected to each other via a bus line 509. Here, the input device 505 and the display device 506 may be used by being connected to the external I/F 508.

The CPU 501 is an arithmetic device that reads programs and data from a storage device, such as the ROM 502 or the HDD 504 onto the RAM 503 and executes processing to realize the control and functions of the entire computer 500. The computer 500 may include a graphics processing unit (GPU) in addition to the CPU 501 or in place of the CPU 501.

The ROM 502 is an example of a nonvolatile semiconductor memory (storage device) that can retain programs and data even when the power is turned off. The ROM 502 functions as a main storage device that stores various programs, data, and the like necessary for the CPU 501 to execute various programs installed in the HDD 504. Specifically, the ROM 502 stores a boot program, such as a basic input/output system (BIOS) or an extensible firmware interface (EFI) that are executed when the computer 500 is started, and data, such as operating system (OS) settings and network settings.

The RAM 503 is an example of a volatile semiconductor memory (storage device) in which programs and data are erased when the power is turned off. The RAM 503 is, for example, a dynamic random access memory (DRAM) or a static random access memory (SRAM). The RAM 503 provides a work area deployed when various programs installed in the HDD 504 are executed by the CPU 501.

The HDD 504 is an example of a nonvolatile storage device that stores programs and data. The programs and data stored in the HDD 504 include the OS, which is a basic software for controlling the entire computer 500, applications that provide various functions on the OS, and the like. Here, instead of the HDD 504, the computer 500 may use a storage device (for example, a solid state drive (SSD) or the like) that uses a flash memory as a storage medium.

The input device 505 is a touch panel used by the user to input various signals, operation keys and buttons, a keyboard and mouse, a microphone that receives sound data such as sound, or the like.

The display device 506 includes a display such as a liquid crystal, or an organic electro-luminescence (EL) for displaying a screen, and a speaker for outputting sound data such as voice.

The communication I/F 507 is an interface for connecting to a communication network and for the computer 500 performing data communication.

The external I/F 508 is an interface with an external device. The external device is a drive device 510 or the like.

The drive device 510 is a device for setting a recording medium 511. The recording medium 511 here includes a medium for recording information optically, electrically, or magnetically, such as a CD-ROM, a flexible disk, a magneto-optical disk, or the like. Additionally, the recording medium 511 may include a semiconductor memory or the like for recording information electrically, such as a ROM or a flash memory. With this, the computer 500 can read and/or write the recording medium 511 via the external I/F 508.

Here, various programs to be installed on the HDD 504 are installed by, for example, setting the distributed recording medium 511 to the drive device 510 connected to the external I/F 508, and reading various programs recorded on the recording medium 511 by the drive device 510. Alternatively, various programs to be installed on the HDD 504 may be installed by downloading from a network other than the communication network via the communication I/F 507.

### Functional Configuration of the Planning Device

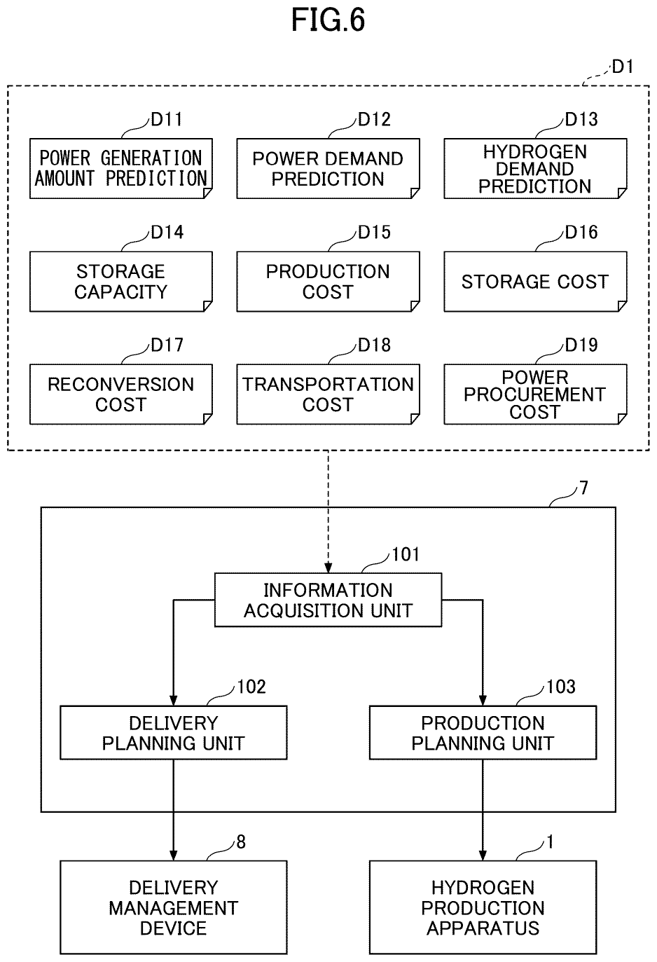

A functional configuration of the planning device 7 in the present embodiment will be described with reference to FIG. 6. FIG. 6 is a block diagram illustrating an example of the functional configuration of the planning device in the present embodiment.

### Functional Configuration of Planning Device

As illustrated in FIG. 6, the planning device 7 in the present embodiment includes an information acquisition unit 101, a delivery planning unit 102, and a production planning unit 103.

The information acquisition unit 101, the delivery planning unit 102, and the production planning unit 103 are realized through processing executed by the CPU 501, for example. The CPU 501 is caused to execute the processing by a program deployed on the RAM 503 from the HDD 504 illustrated in FIG. 5.

The information acquisition unit 101 acquires information (hereinafter also referred to as “consumption region information”) D1 related to the consumption region R2 for each of the consumption regions R2. The consumption region information D1 includes information related to hydrogen production, information related to hydrogen demand, and information related to hydrogen supply cost.

Specifically, the consumption region information D1 includes power generation amount prediction D11, power demand prediction D12, hydrogen demand prediction D13, storage capacity D14, production cost D15, storage cost D16, reconversion cost D17, transportation cost D18, and power procurement cost D19.

The power generation amount prediction D11 is a result of predicting the amount of generated power derived from renewable energy in a predetermined planning period. The electric power demand prediction D12 is a result of predicting the amount of demand for electric power in the predetermined planning period. The hydrogen demand prediction D13 is a result of predicting the amount of demand for hydrogen in the predetermined planning period. The storage capacity D14 is a result of predicting the storage capacity of the hydrogen carrier tank 4 in the predetermined planning period.

The predetermined planning period is a time period to be targeted in the delivery plan. The predetermined planning period may be determined according to the time interval for which the prediction results can be obtained. The predetermined planning period may range from several weeks to several months, for example.

Here, the power generation amount prediction D11, the electric power demand prediction D12, the hydrogen demand prediction D13, and the storage capacity D14 may be predicted by statistical processing of time-series data representing data for the past several years, or may be predicted by simulation, machine learning, or the like, for example. The power generation amount prediction D11, the electric power demand prediction D12, the hydrogen demand prediction D13, and the storage capacity D14 may be predicted by an external device or system different from the planning device 7, or predicted by the planning device 7.

The production cost D15 is the cost required to produce hydrogen in the consumption region R2. The production cost D15 may include the cost required for operation, maintenance, or renewal of the hydrogen production apparatus 1. Here, the production cost D15 does not include the cost related to the electric power used to produce hydrogen.

The storage cost D16 is the cost required to store the hydrogen carrier in the consumption region R2. The storage cost D16 may include the cost required for operation, maintenance or renewal of the hydrogen carrier tank 4.

The reconversion cost D17 is the cost required to reconvert the hydrogen carrier into hydrogen in the consumption region R2. The reconversion cost D17 may include, for example, the cost of dehydrogenating methylcyclohexane, the cost of reacting ammonia with a catalyst, and the cost of vaporizing liquid hydrogen. The reconversion cost D17 may include the cost required for operation, maintenance or renewal of the hydrogen reconversion apparatus 5.

The transportation cost D18 is the cost required to transport the hydrogen carrier from the production site R1 to the consumption region R2. The transportation cost D18 may include, for example, the cost required for operation, maintenance or renewal of a tanker or a tank lorry that transports the hydrogen carrier from the production site R1 to the consumption region R2.

Here, the transportation cost D18 may include the cost of distributing the hydrogen or the hydrogen carrier to the consumer C in the consumption region R2. The cost of distributing the hydrogen to the consumer C may include the cost required to transport, to the consumer C, the hydrogen reconverted from the hydrogen carrier stored in the hydrogen carrier tank 4. The cost of distributing the hydrogen carrier to the consumer C may include the cost required to transport the hydrogen carrier from the hydrogen carrier tank 4 to the consumer C.

The electric power procurement cost D19 is the cost for procuring the electric power required to produce hydrogen in the consumption region R2. The electric power procurement cost D19 may include, for example, the price of electric power derived from renewable energy supplied from the transmission grid G in the consumption region R2. The electric power procurement cost D19 may include the cost of operation, maintenance, or renewal of the power generation facility installed in the consumption region R2.

Here, in the present embodiment, the power generation amount prediction D11, the electric power demand prediction D12, and the storage capacity D14 are examples of the information related to the hydrogen production. The hydrogen demand prediction D13 is an example of the information related to the hydrogen demand. The production cost D15, the storage cost D16, the reconversion cost D17, the transportation cost D18, and the electric power procurement cost D19 are examples of the information related to the hydrogen supply cost.

The delivery planning unit 102 creates a delivery plan in the predetermined planning period for each of the consumption regions R2 based on the consumption region information D1 acquired by the information acquisition unit 101. The delivery plan is a plan for delivering the hydrogen carrier from the production site R1 to each of the consumption regions R2. The delivery plan includes at least the delivery amount of the hydrogen carrier to be delivered to each of the consumption regions R2. The delivery plan may include the order or route of delivering the hydrogen carrier to each of the consumption regions R2.

The delivery plan may be created for each transaction for purchasing the hydrogen carrier or for each tanker that transports the hydrogen carrier. Additionally, the delivery plan may be created for the amount of the hydrogen carrier transported by one tanker or for the total amount of the hydrogen carrier transported by a plurality of tankers.

The delivery planning unit 102 creates the delivery plan by mathematical optimization such as mathematical programming. In the present embodiment, a method of mathematical optimization is not limited. The delivery planning unit 102 performs optimization calculation, using, as a constraint, a condition that the amount of hydrogen supplied meets the demand for hydrogen, and using, as an objective function, minimizing the cost of the supplied hydrogen. The amount of the supplied hydrogen includes the amount of hydrogen produced in the consumption region R2 and the amount of hydrogen acquired by reconverting the hydrogen carrier delivered to the consumption region R2. The cost of the supplied hydrogen includes the production cost, the storage cost, the reconversion cost, the transportation cost, and the electric power procurement cost.

The production planning unit 103 creates a production plan in the predetermined planning period based on the consumption region information D1 acquired by the information acquisition unit 101. The production plan is a plan for producing hydrogen in each of the consumption regions R2. The production plan includes at least the amount of hydrogen produced in each of the consumption regions R2.

The production planning unit 103 creates the production plan by mathematical optimization in the same manner as the delivery planning unit 102. The constraint condition and the objective function of the mathematical optimization are substantially the same as the constraint condition and the objective function of the delivery planning unit 102.

### Processing Procedure of Energy Supply Method

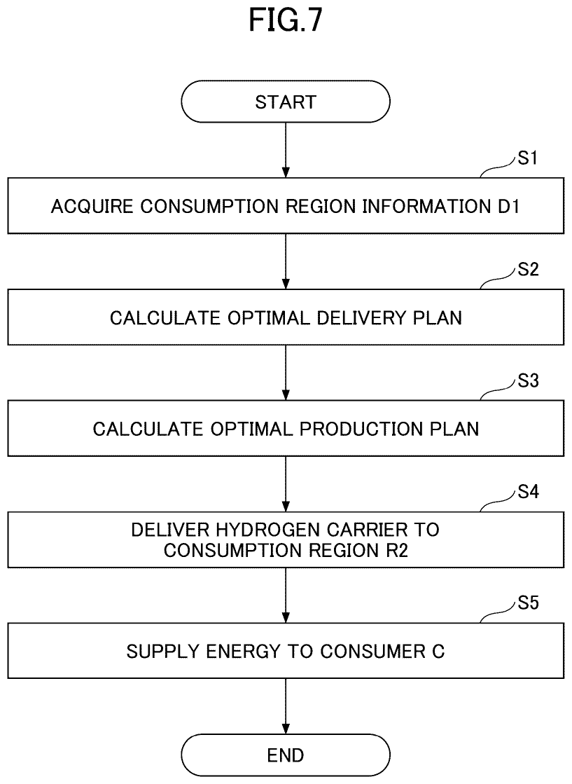

An energy supply method in the present embodiment will be described with reference to FIG. 7. FIG. 7 is a flowchart illustrating an example of the energy supply method in the present embodiment.

In step S1, the information acquisition unit 101 of the planning device 7 acquires the consumption region information D1 related to the consumption region R2 for each of the consumption regions R2. The consumption region information D1 includes the power generation amount prediction D11, the electric power demand prediction D12, and the like. Next, the information acquisition unit 101 transmits the acquired consumption region information D1 to the delivery planning unit 102 and the production planning unit 103.

In step S2, the delivery planning unit 102 of the planning device 7 receives the consumption region information D1 for each of the consumption regions R2 from the information acquisition unit 101. Next, the delivery planning unit 102 creates the delivery plan by mathematical optimization based on the consumption region information D1. Then, the delivery planning unit 102 transmits the created delivery plan to the delivery management device 8.

In step S3, the production planning unit 103 of the planning device 7 receives the consumption region information D1 for each of the consumption regions R2 from the information acquisition unit 101. Next, the production planning unit 103 creates the production plan by mathematical optimization based on the consumption region information D1. Then, the production planning unit 103 transmits the created production plan to the hydrogen production apparatus 1.

The hydrogen production apparatus 1 receives the production plan from the planning device 7. The hydrogen production apparatus 1 produces hydrogen according to the production plan. The hydrogen produced by the hydrogen production apparatus 1 is stored in the hydrogen tank 2.

In step S4, the delivery management device 8 receives the delivery plan from the planning device 7. Next, the delivery management device 8 transmits the delivery instruction for delivering the hydrogen carrier to each of the consumption regions R2 to the delivery subject of the hydrogen carrier according to the delivery plan. The delivery subject of the hydrogen carrier delivers the hydrogen carrier to each of the consumption regions R2 according to the delivery instruction received from the delivery management device 8.

In step S5, the delivery management device 8 transmits the delivery instruction for distributing the hydrogen energy to the consumer C in each of the consumption regions R2 according to the delivery plan received in step S4 to the delivery subject of the hydrogen energy. The delivery subject of the hydrogen energy delivers the hydrogen energy to each consumer C according to the delivery instruction received from the delivery management device 8.

The consumer C generates electric energy using the delivered hydrogen energy. For example, the consumer C having received the delivery of the hydrogen inputs the delivered hydrogen into a fuel cell. With this, the consumer C can generate electric power by using hydrogen produced by electric power derived from renewable energy, thereby reducing carbon dioxide emissions.

Additionally, for example, the consumer C having received the delivery of the hydrogen carrier inputs the delivered hydrogen carrier into a fuel cell. The fuel cell has a function of internally dehydrogenating the hydrogen carrier to generate hydrogen and generating electric power by using the hydrogen. With this, the consumer C can generate electric power by using the hydrogen carrier produced by electric power derived from renewable energy, thereby reducing carbon dioxide emissions.

### Effect of First Embodiment

The planning device 7 in the present embodiment creates the delivery plan for delivering the hydrogen or the hydrogen carrier from the production site where the hydrogen or the hydrogen carrier is produced, to each of a plurality of consumption regions where storage facilities for the hydrogen or the hydrogen carrier are installed. Therefore, according to the present embodiment, the hydrogen or the hydrogen carrier can be appropriately delivered to the consumption region where the hydrogen or the hydrogen carrier is consumed.

The planning device 7 in the present embodiment may determine the delivery amount of the hydrogen or the hydrogen carrier so that the supply amount of the hydrogen meets the demand for hydrogen. Therefore, according to the present embodiment, the delivery plan can be created to meet the demand and supply of hydrogen.

The planning device 7 in the present embodiment may create the delivery plan so as to minimize the cost of the hydrogen supply. Furthermore, the planning device 7 may create the production plan so as to minimize the cost of hydrogen supply. Therefore, according to the present embodiment, the delivery plan or the production plan can be created so that the profit obtained by the supply of the energy is maximized.

The cost of the hydrogen supply in the present embodiment may include the cost of delivering, to the consumer, the hydrogen obtained by reconverting the hydrogen carrier stored in the storage facility and the cost of delivering, to the consumer, the hydrogen carrier stored in the storage facility. Therefore, according to the present embodiment, even in the case of including a form of supplying, to the consumer C, the hydrogen reconverted from the hydrogen carrier in the consumption region R2 and a form of supplying, to the consumer C, the hydrogen carrier as it is, the delivery plan or the production plan can be created so as to minimize the hydrogen supply cost.

In the energy supply system according to the present embodiment, hydrogen may be produced using the electric power derived from renewable energy and converted into the hydrogen carrier using the electric power derived from renewable energy. Therefore, according to the present embodiment, carbon dioxide emissions can be greatly reduced in the entire cycle from the production to the use of energy, and decarbonization can be promoted.

### Modified Example 1

In the first embodiment, the example of creating the delivery plan and the production plan individually by mathematical optimization calculation has been described, but the delivery plan and the production plan may be created simultaneously by one mathematical optimization calculation.

In the energy supply system according to a modified example 1, it is only required to configure the planning device 7 to include a planning unit integrating the delivery planning unit 102 and the production planning unit 103. Additionally, in the energy supply method according to the modified example 1, the planning unit of the planning device 7 is only required to simultaneously perform step S2 and step S3 of the energy supply method according to the first embodiment.

### Second Embodiment

In the first embodiment, the mathematical optimization is performed to meet the demand and supply of hydrogen based on the prediction of the power generation from renewable energy. In a second embodiment, mathematical optimization is performed to meet the demand and supply of hydrogen based on the hydrogen production plan in the consumption region R2.

In the following, the energy supply system of the present embodiment will be described, focusing on the differences from the first embodiment.

### Functional Configuration of Planning Device

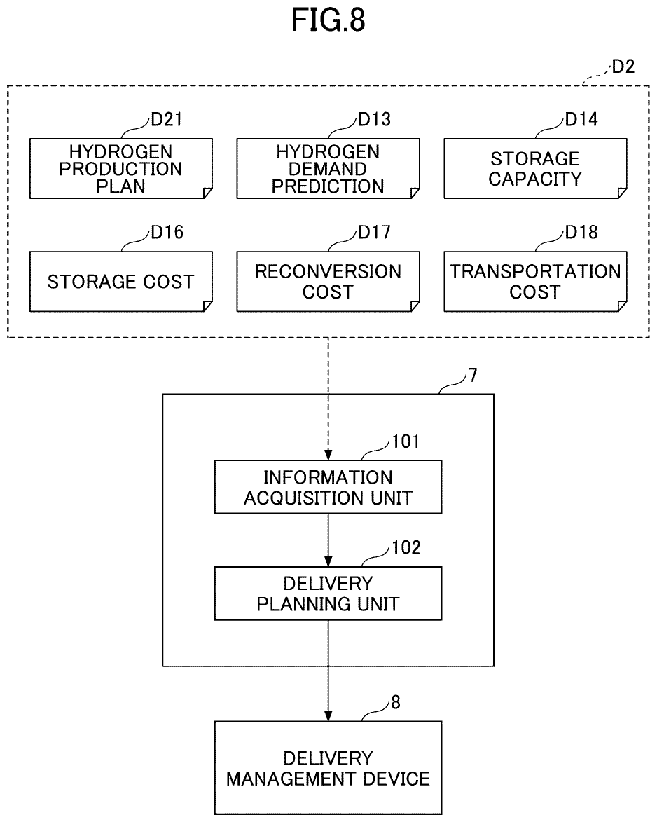

A functional configuration of a planning device 7 of the present embodiment will be described with reference to FIG. 8. FIG. 8 is a block diagram illustrating an example of the functional configuration of the planning device of the present embodiment.

### Functional Configuration of Planning Device

As illustrated in FIG. 8, the planning device 7 of the present embodiment includes the information acquisition unit 101 and the delivery planning unit 102. That is, the planning device 7 of the present embodiment is different from the first embodiment in that the production planning unit 103 is not included.

The information acquisition unit 101 of the present embodiment acquires consumption region information D2 related to the consumption region R2 for each of the consumption regions R2. The consumption region information D2 in the present embodiment includes a hydrogen production plan D21, the hydrogen demand prediction D13, the storage capacity D14, the storage cost D16, the reconversion cost D17, and the transportation cost D18. That is, the consumption region information D2 in the present embodiment is different from the consumption region information D1 in the first embodiment in that the power generation amount prediction D11, the electric power demand prediction D12, the production cost D15, and the electric power procurement cost D19 are not included, but the hydrogen production plan D21 is further included.

In the present embodiment, when there is no hydrogen production facility in the consumption region R2, the hydrogen production plan D21 is information indicating that the hydrogen production amount is 0.

Here, in the present embodiment, the hydrogen production plan D21 and the storage capacity D14 are examples of the information related to the hydrogen production. The hydrogen demand prediction D13 is an example of the information related to the hydrogen demand. The storage cost D16, the reconversion cost D17, and the transportation cost D18 are examples of the information related to the hydrogen supply cost.

### Processing Procedure of Energy Supply Method

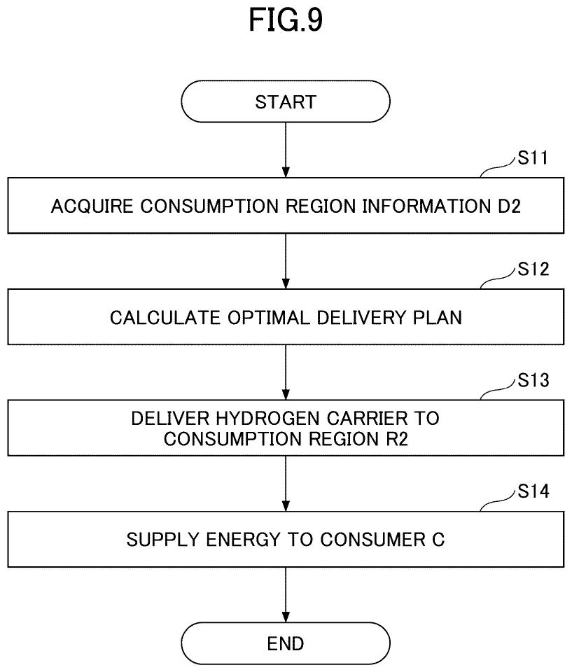

An energy supply method in the present embodiment will be described with reference to FIG. 9. FIG. 9 is a flowchart illustrating an example of the energy supply method in the present embodiment.

In step S11, the information acquisition unit 101 of the planning device 7 acquires the consumption region information D2 related to the consumption region R2 for each of the consumption regions R2. The consumption region information D2 includes the hydrogen production plan D21, and the like. Next, the information acquisition unit 101 transmits the acquired consumption region information D2 to the delivery planning unit 102.

The processing from step S12 to step S14 is substantially the same as steps S2, S4, and S5 of the energy supply method in the first embodiment (see FIG. 7).

### Effect of the Second Embodiment

In the planning device 7 of the present embodiment, the information related to the hydrogen production includes the production plan in the production facility. If the amount of hydrogen production can be obtained from the production plan, the amount of the hydrogen production in the consumption region can be accurately grasped. Therefore, according to the present embodiment, the delivery plan can be accurately created.

### Modified Example 2

In the second embodiment, an example in which only the delivery plan is created by the mathematical optimization calculation has been described, but the hydrogen production plan may be modified by the mathematical optimization calculation.

In the energy supply system according to a modified example 2, it is only required to configure the planning device 7 to include a planning unit that integrates the delivery planning unit 102 and the production planning unit 103. The consumption region information D2 in this modified example includes the hydrogen production plan D21, the electric power demand prediction D12, the hydrogen demand prediction D13, the storage capacity D14, the production cost D15, the storage cost D16, the reconversion cost D17, the transportation cost D18, and the electric power procurement cost D19. That is, the consumption region information D2 in this modified example is different from the consumption region information D2 in the second embodiment in that the electric power demand prediction D12, the production cost D15, and the electric power procurement cost D19 are included.

The planning unit of the planning device 7 is only required to create the delivery plan by mathematical optimization based on the consumption region information D2 in this modified example, and simultaneously modify the hydrogen production plan D21. The planning unit of the planning device 7 is only required to transmit the modified hydrogen production plan D21 to the hydrogen production apparatus 1.

### Supplement

Each of the functions of the above-described embodiments can be implemented by one or more processing circuitry. Here, the term “processing circuitry” in the present specification includes a processor programmed to execute each function by software, such as a central processing unit (CPU) or a graphics processing unit (GPU) implemented by an electronic circuit, and equipment such as an application specific integrated circuit (ASIC), a digital signal processor (DSP), a field programmable gate array (FPGA), or a conventional circuit module designed to execute each of the above-described functions.

It should be noted that the disclosed technology may be in the form of clauses described below.

### Clause 1

A planning device including:
an information acquisition unit configured to acquire information related to hydrogen production and information related to hydrogen demand with respect to each of a plurality of regions, a storage facility of hydrogen or a hydrogen carrier being installed in each of the plurality of regions; and
a delivery planning unit configured to create a delivery plan for delivering, to the storage facility, the hydrogen or the hydrogen carrier produced at a production site different from the plurality of regions, based on the information related to the hydrogen production and the information related to the hydrogen demand.

### Clause 2

The planning device as described in Clause 1, wherein the delivery planning unit determines a delivery amount of the hydrogen carrier with respect to each of the plurality of regions so that a hydrogen supply amount based on the information related to the hydrogen production and the delivery plan meets the hydrogen demand.

### Clause 3

The planning device as described in Clause 2, wherein the information related to the hydrogen production includes prediction of a power generation amount derived from renewable energy.

### Clause 4

The planning device as described in Clause 3,
wherein the information acquisition unit further acquires information related to electric power demand in each of the plurality of regions, and
wherein the delivery planning unit creates the delivery plan based on the information related to the hydrogen production, the information related to the hydrogen demand, and the information related to the electric power demand.

### Clause 5

The planning device as described in Clause 2, wherein the information related to the hydrogen production includes a hydrogen production plan in a hydrogen production facility installed in the region.

### Clause 6

The planning device as described in Clause 2,
wherein the information acquisition unit further acquires information related to a hydrogen supply cost for each of the plurality of regions, and
wherein the delivery planning unit creates the delivery plan so as to minimize the hydrogen supply cost for each of the plurality of regions.

### Clause 7

The planning device as described in Clause 6, further comprising a production planning unit configured to create a hydrogen production plan in a hydrogen production facility installed in the region so as to minimize the hydrogen supply cost for each of the plurality of regions.

### Clause 8

The planning device as described in Clause 6, wherein the hydrogen supply cost includes a production cost of the hydrogen, a reconversion cost of the hydrogen carrier, a storage cost of the hydrogen carrier, a transportation cost of the hydrogen carrier, and a power procurement cost for producing the hydrogen.

### Clause 9

The planning device as described in Clause 8, wherein the transportation cost of the hydrogen carrier includes a cost of transporting, to a consumer, hydrogen obtained by reconverting the hydrogen carrier stored in the storage facility, and a cost of transporting the hydrogen carrier stored in the storage facility to the consumer.

### Clause 10

The planning device as described in any one of Clauses 1 to 9, wherein the delivery planning unit creates the delivery plan by mathematical optimization.

### Clause 11

The planning device as described in any one of Clauses 1 to 9, wherein the hydrogen carrier is produced using electric power derived from renewable energy.

### Clause 12

The planning device as described in any one of Clauses 1 to 9, wherein the hydrogen carrier includes at least one of methylcyclohexane, ammonia, or liquid hydrogen.

### Clause 13

A planning method of performing, by a planning device:
a procedure of acquiring information related to hydrogen production and information related to hydrogen demand with respect to each of a plurality of regions, a storage facility of hydrogen or a hydrogen carrier being installed in each of the plurality of regions; and
a procedure of creating a delivery plan for delivering, to the storage facility, the hydrogen or the hydrogen carrier produced at a production site different from the plurality of regions, based on the information related to the hydrogen production and the information related to the hydrogen demand.

### Clause 14

An energy supply method including:
a step of delivering the hydrogen carrier from the production site to each of the plurality of regions according to the delivery plan created by the planning method as claimed in claim 13;
a step of distributing the hydrogen carrier stored in the storage facility to a consumer located in the region; and
a step of generating electric power by using the hydrogen carrier distributed to the consumer.

### Clause 15

An energy supply method including:
a step of delivering the hydrogen carrier from the production site to each of the plurality of regions according to the delivery plan created by the planning method as claimed in claim 13;
a step of converting the hydrogen carrier stored in the storage facility to hydrogen;
a step of distributing the hydrogen to a consumer located in the region; and
a step of generating electric power by using the hydrogen distributed to the consumer.

Although the embodiments of the present invention have been described in detail above, the present invention is not limited to these embodiments, and various modifications and changes can be made in various ways within the scope of the gist of the present invention described in the claims.

This application claims priority to Japanese Patent Application No. 2023-53766, filed with the Japan Patent Office on Mar. 29, 2023, and is incorporated herein by reference in its entirety.

### Description of Reference Symbols

1 hydrogen production apparatus
2 hydrogen tank
3 hydrogen carrier production apparatus
4 hydrogen carrier tank
5 hydrogen reconversion apparatus
6 hydrogen purification apparatus
7 planning device
8 delivery management device
10 hydrogen carrier production system
101 information acquisition unit
102 delivery planning unit
103 production planning unit

1. A planning device comprising:
a processor; and
a memory storing program instructions that cause the processor to:
acquire information related to hydrogen production and information related to hydrogen demand with respect to each of a plurality of regions, a storage facility of hydrogen or a hydrogen carrier being installed in each of the plurality of regions;
create a delivery plan for delivering, to the storage facility, the hydrogen or the hydrogen carrier produced at a production site different from the plurality of regions, based on the information related to the hydrogen production and the information related to the hydrogen demand; and
transmit a delivery instruction to a delivery subject, based on the delivery plan, to deliver the hydrogen or the hydrogen carrier to the storage facility.

2. The planning device as claimed in claim 1, wherein the program instructions cause the processor to determine a delivery amount of the hydrogen carrier with respect to each of the plurality of regions so that a hydrogen supply amount based on the information related to the hydrogen production and the delivery plan meets the hydrogen demand.

3. The planning device as claimed in claim 2, wherein the information related to the hydrogen production includes prediction of a power generation amount derived from renewable energy.

4. The planning device as claimed in claim 3,
wherein the program instructions cause the processor to acquire information related to electric power demand in each of the plurality of regions, and
wherein the program instructions cause the processor to create the delivery plan based on the information related to the hydrogen production, the information related to the hydrogen demand, and the information related to the electric power demand.

5. The planning device as claimed in claim 2, wherein the information related to the hydrogen production includes a hydrogen production plan in a hydrogen production facility installed in the region.

6. The planning device as claimed in claim 2,
wherein the program instructions cause the processor to acquire information related to a hydrogen supply cost for each of the plurality of regions, and
wherein the program instructions cause the processor to create the delivery plan so as to minimize the hydrogen supply cost for each of the plurality of regions.

7. The planning device as claimed in claim 6, wherein the program instructions cause the processor to create a hydrogen production plan in a hydrogen production facility installed in the region so as to minimize the hydrogen supply cost for each of the plurality of regions.

8. The planning device as claimed in claim 6, wherein the hydrogen supply cost includes a production cost of the hydrogen, a reconversion cost of the hydrogen carrier, a storage cost of the hydrogen carrier, a transportation cost of the hydrogen carrier, and a power procurement cost for producing the hydrogen.

9. The planning device as claimed in claim 8, wherein the transportation cost of the hydrogen carrier includes a cost of transporting, to a consumer, hydrogen obtained by reconverting the hydrogen carrier stored in the storage facility, and a cost of transporting the hydrogen carrier stored in the storage facility to the consumer.

10. The planning device as claimed in claim 1, wherein the program instructions cause the processor to create the delivery plan by mathematical optimization.

11. The planning device as claimed in claim 1, wherein the hydrogen carrier is produced using electric power derived from renewable energy.

12. The planning device as claimed in claim 1, wherein the hydrogen carrier includes at least one of methylcyclohexane, ammonia, or liquid hydrogen.

13. A planning method of performing, by a planning device:
acquiring information related to hydrogen production and information related to hydrogen demand with respect to each of a plurality of regions, a storage facility of hydrogen or a hydrogen carrier being installed in each of the plurality of regions;
creating a delivery plan for delivering, to the storage facility, the hydrogen or the hydrogen carrier produced at a production site different from the plurality of regions, based on the information related to the hydrogen production and the information related to the hydrogen demand; and
transmitting a delivery instruction to a delivery subject, based on the delivery plan, to deliver the hydrogen or the hydrogen carrier to the storage facility.

14. An energy supply method comprising:
delivering the hydrogen carrier from the production site to each of the plurality of regions according to the delivery plan created by the planning method as claimed in claim 13;
distributing the hydrogen carrier stored in the storage facility to a consumer located in the region; and
generating electric power by using the hydrogen carrier distributed to the consumer.

15. An energy supply method comprising:
delivering the hydrogen carrier from the production site to each of the plurality of regions according to the delivery plan created by the planning method as claimed in claim 13;
converting the hydrogen carrier stored in the storage facility to hydrogen;
distributing the hydrogen to a consumer located in the region; and
generating electric power by using the hydrogen distributed to the consumer.
